(19) United States
(12) Patent Application Publication
(10) Pub. No.: US 2011/0154940 A1
(43) Pub. Date: Jun. 30, 2011

(54) CLAMPING AND SEALING MECHANISM FOR A CABLE

(75) Inventor: Andre Joseph Claude GAGNE, Milton (CA)

(73) Assignee: PSION TEKLOGIX INC., Mississauga (CA)

(21) Appl. No.: 12/649,990

(22) Filed: Dec. 30, 2009

(51) Int. Cl. F16C 1/10; B23P 17/00

(52) U.S. Cl. 74/502.6; 29/527.1

(57) ABSTRACT

A strain relief for a cable and its method are provided. A strain relief for a cable, includes: a first member including: a main body having an opening for receiving a cable and a locking member, and a second complementary member including: a main body having an opening for receiving the cable; and at least one flexible finger having a finger body extending from the main body of the second complementary member, an inner barb formed at an inner end of the finger body for engaging into the outer jacket of the cable upon insertion of the complementary second member into the main body of the first member, and an outer barb formed at an outer end of the finger body for snapping into the locking member. A method for a cable strain relief having a first member and a second member, includes: inserting at least one flexible finger of the second member together with a cable into the main body of the first member, including: compressing the finger of the second member into an outer jacket of the cable so that the inner barb of the finger pinches the outer jacket; and snapping the outer barb of the finger into the locking member of the first member. A strain relief for a cable, includes: a main body having a substantially cylindrical inner space defined by an inner surface; and a plurality of resilient locking barbs on the inner surface of the main body, extending to the longitudinal axis of the main body, for deflecting upon insertion of a cable into the inner space and snapping the an outer jacket of the cable. A method for a cable strain relief, includes; inserting a cable into the inner space of a strain relief main body so that the barbs of the main body deflect and snap an outer jacket of the cable; and overmolding the main body together with the cable.

### FIELD OF INVENTION

The present invention relates to a cable assembly, and more specifically to a panel mounted strain relief for clamping and sealing a cable.

### BACKGROUND OF THE INVENTION

Cable strain reliefs for securing a cable to an equipment are well known in the art. Most of the cable water tight strain reliefs use a compression fit mechanism to compress a gasket over the cable. The compression fit mechanism typically uses a compression nut to be tightened such that the sealing gasket could be compressed over the cable. This ensures a sufficient ingress protection (IP) seal of the coupling.

However, the compression fit mechanism requires multiple parts including the compression nut and a special install device to handle the multiple parts, thereby increasing the complexity of the assembly.

### SUMMARY OF THE INVENTION

It is an object of the invention to provide a clamping and sealing mechanism for a cable, which obviates or mitigates at least one of the disadvantages of existing systems.

According to an aspect of the present invention there is provided a strain relief for a cable, which includes: a first member including: a main body having an opening for receiving a cable and a locking member, and a second complementary member including: a main body having an opening for receiving the cable; and at least one flexible finger having a finger body extending from the main body of the second complementary member, an inner barb formed at an inner end of the finger body for engaging into the outer jacket of the cable upon insertion of the complementary second member into the main body of the first member, and an outer barb formed at an outer end of the finger body for snapping into the locking member.

According to another aspect of the present invention there is provided a method for a cable strain relief. The strain relief includes a first member and a second member. The first member has a main body having an opening for receiving a cable and a locking member. The second member has a main body having an opening for receiving the cable and at least one flexible finger. The main body of the second member has a first end and a second end. The finger has a finger body extending from the second end of the second member and inner and outer barbs formed at the end of the finger body. The method includes the steps of: inserting the at least one flexible finger together with the cable into the main body of the first member, including: compressing the finger of the second member into an outer jacket of the cable so that the inner barb of the finger pinches the outer jacket; and snapping the outer barb of the finger into the locking member of the first member.

According to a further aspect of the present invention there is provided a strain relief for a cable, which includes: a main body having a substantially cylindrical inner space defined by an inner surface; and a plurality of resilient locking barbs on the inner surface of the main body, extending to the longitudinal axis of the main body, for deflecting upon insertion of a cable into the inner space and snapping the an outer jacket of the cable.

According to a further aspect of the present invention there is provided a method for a cable strain relief. The strain relief includes a main body having a substantially cylindrical inner space defined by an inner surface, and a plurality of resilient locking barbs on the inner surface of the main body, extending to the longitudinal axis of the main body. The method includes the steps of: inserting a cable into the inner space so that the barbs deflect and snap an outer jacket of the cable; and overmolding the main body together with the cable.

### BRIEF DESCRIPTION OF THE DRAWINGS

These and other features of the invention will become more apparent from the following description in which reference is made to the appended drawings wherein:

FIG. 1 is a perspective front view of a ferrule in accordance with an embodiment of the present application;

FIG. 2 is a perspective bottom view of the ferrule of FIG. 1;

FIG. 3 is a front view of the ferrule of FIG. 1;

FIG. 4 is a side view of the ferrule of FIG. 1;

FIG. 5 is a cross section side view of the ferrule, taken along lines A-A of FIG. 3;

FIG. 6 is another cross section view of the ferrule of FIG. 1 where a cable is inserted into the ferrule;

FIG. 7 is a perspective front view of a bushing in accordance with an embodiment of the present application;

FIG. 8 is a perspective rear view of the bushing of FIG. 7;

FIG. 9 is a front view of the bushing of FIG. 7;

FIG. 10 is a rear view of the bushing of FIG. 7;

FIG. 11 is a cross section side view of the bushing, taken along lines B-B of FIG. 10;

FIG. 12 is a quarter cut out perspective view of the bushing of FIG. 7;

FIG. 13 is another cross section side view of the bushing of FIG. 7 and the ferrule of FIG. 1 where the ferrule, together with the cable, is inserted into the bushing;

FIG. 14 is a partial view of FIG. 13, showing the insertion of the ferrule into the cable;

FIG. 15 is a side view of an overmolded strain relief with the cable in accordance with an embodiment of the present invention;

FIG. 16 is a cross section side view of the strain relief of FIG. 15 where the bushing of FIG. 7, together with the cable and the ferrule of FIG. 1, is overmolded;

FIG. 17 is a partial cross section view of the strain relief of FIG. 16 where the strain relief is inserted into equipment;

FIG. 18 is a partial cross section view of a bushing in accordance with another embodiment of the present invention;

FIG. 19 is a cross section view of a ferrule in accordance with another embodiment of the present invention;

FIG. 20 is another cross section view of a combination of the bushing of FIG. 18 and the ferrule of FIG. 19; and

FIG. 21 is a cut out cross section view of a bushing in accordance with a further embodiment of the present invention.

### DETAILED DESCRIPTION

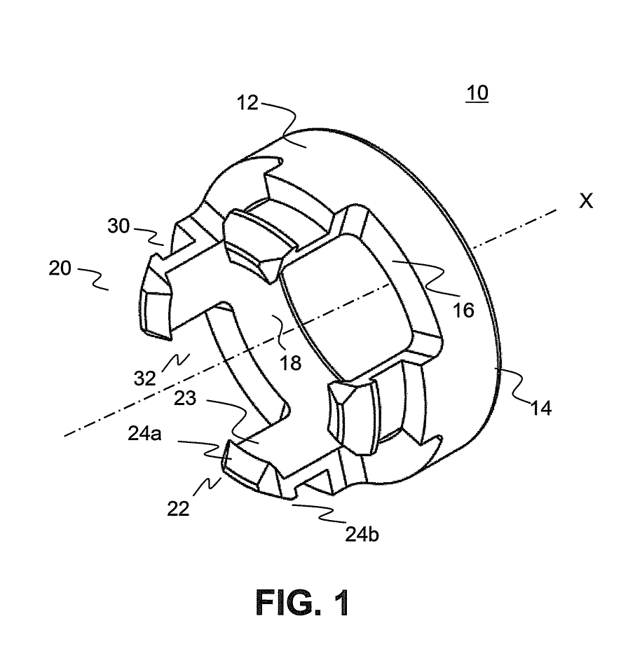

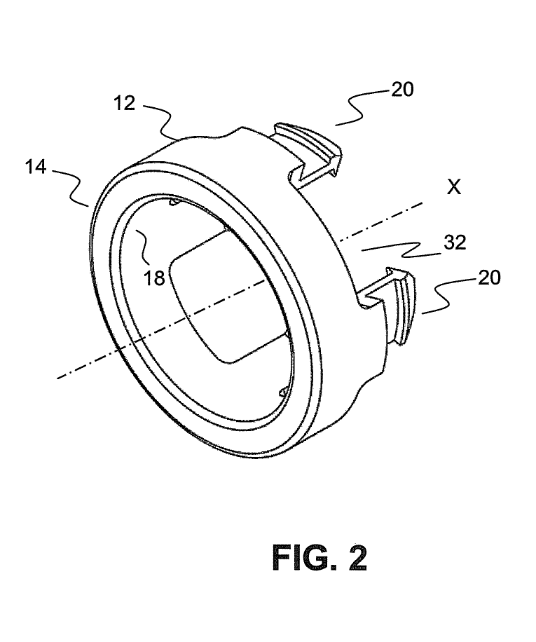

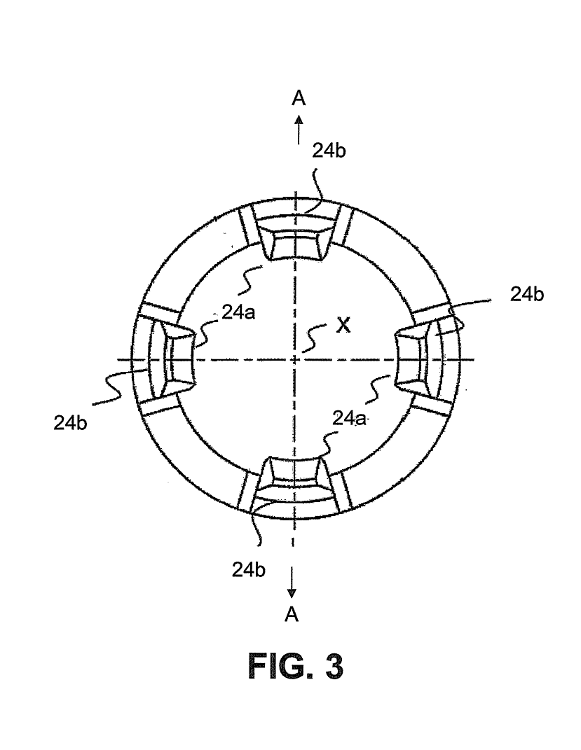

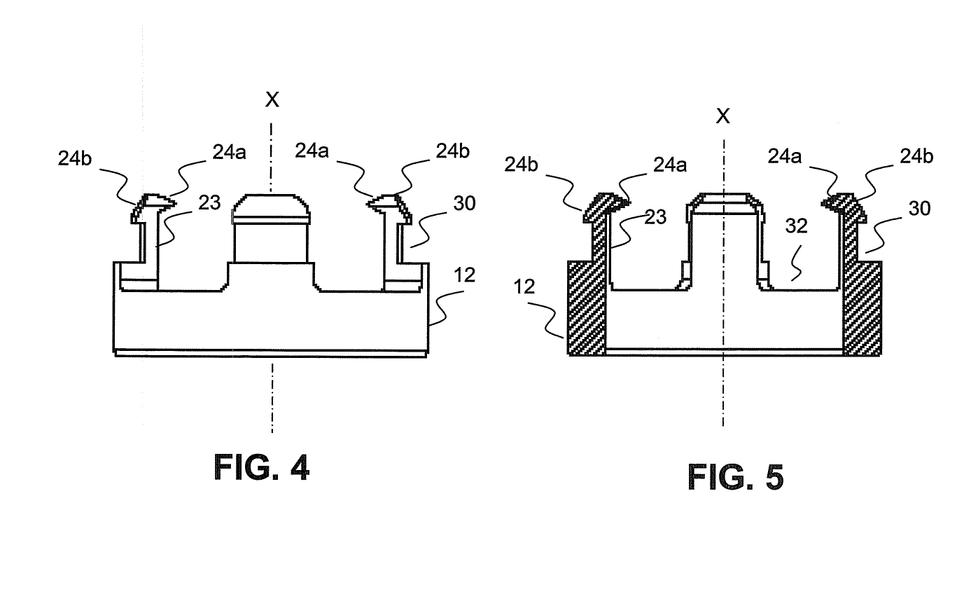

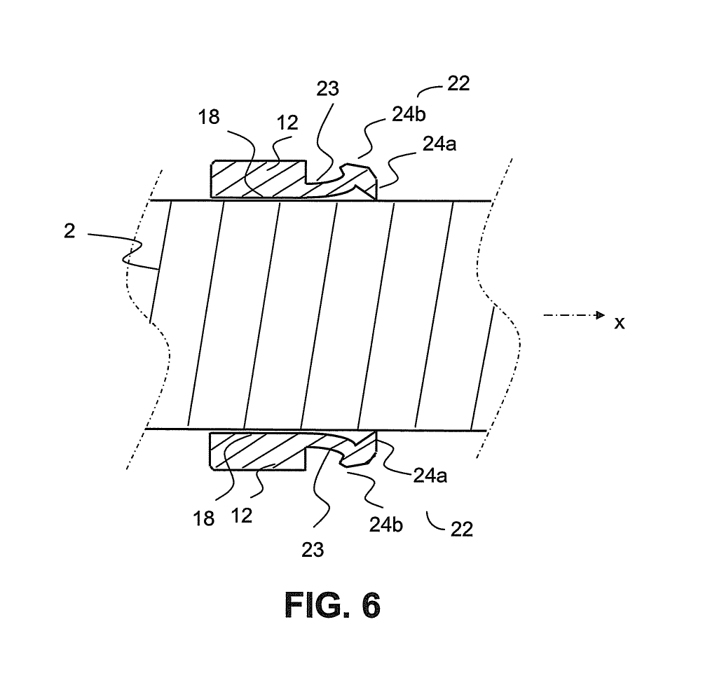

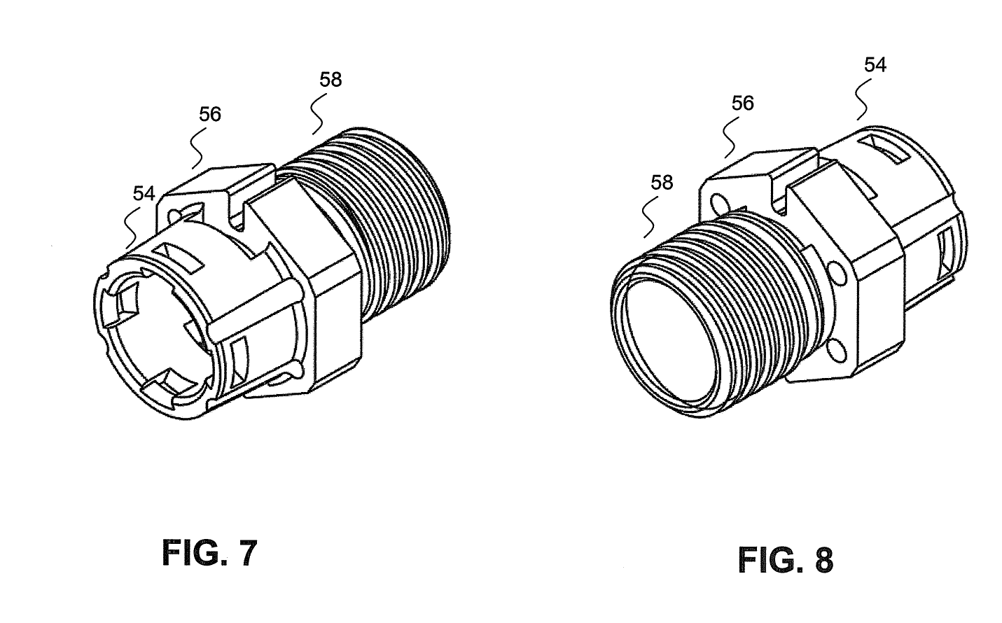

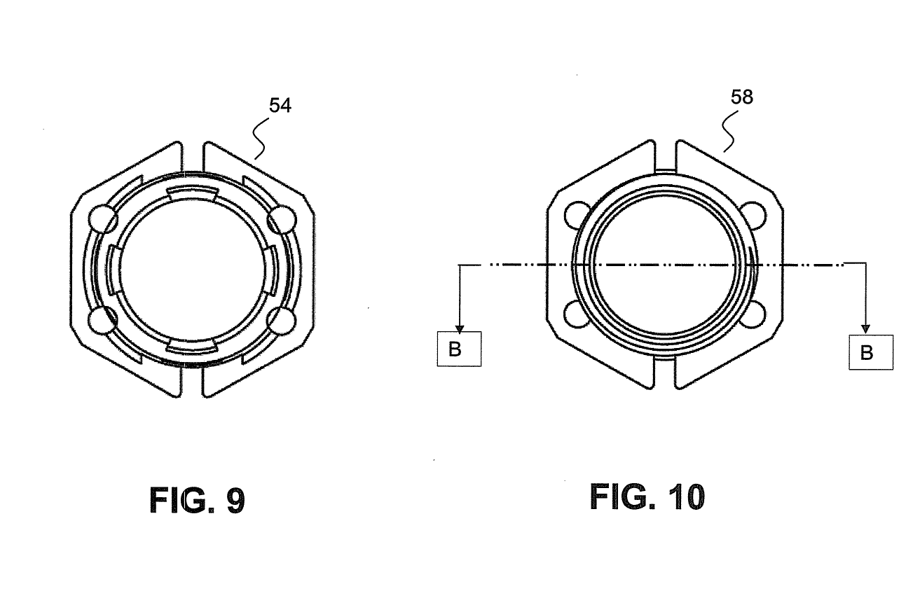

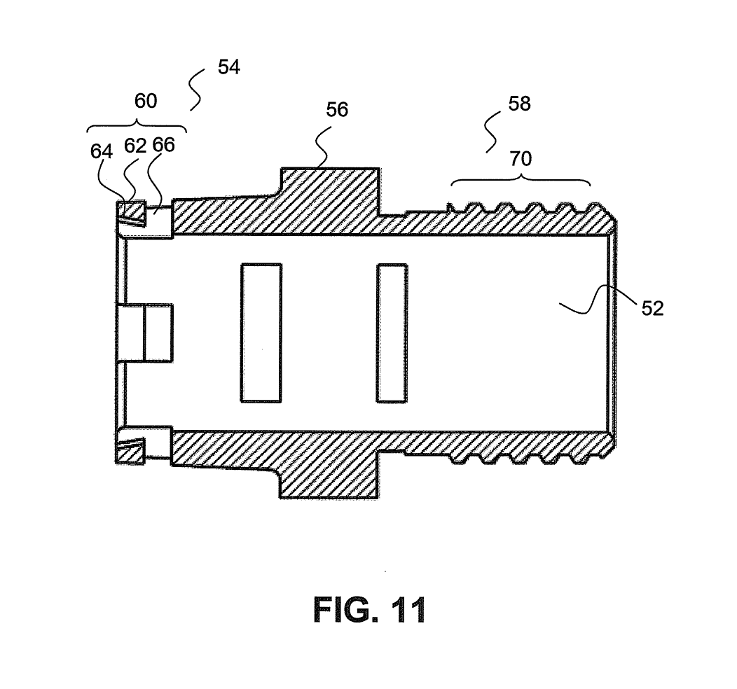

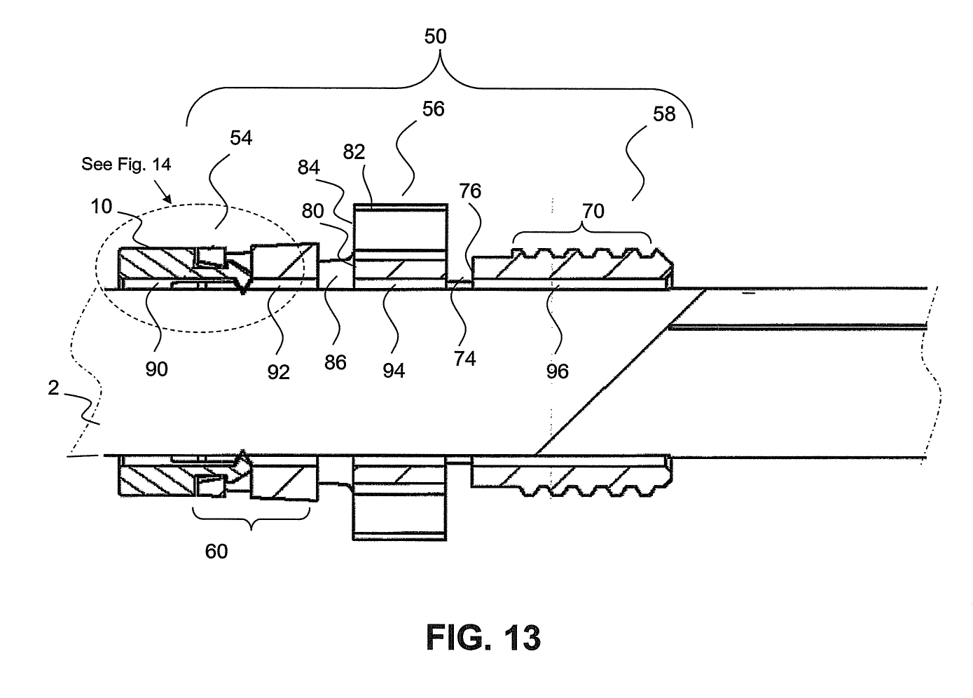

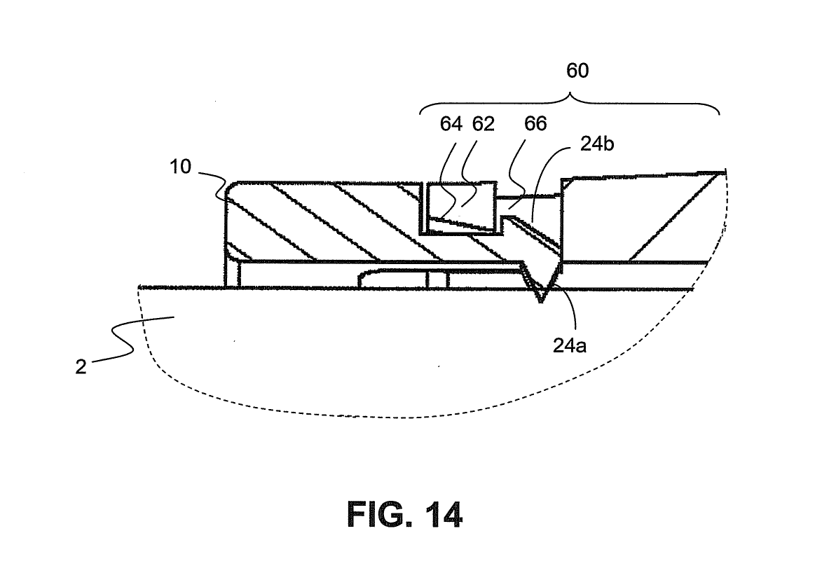

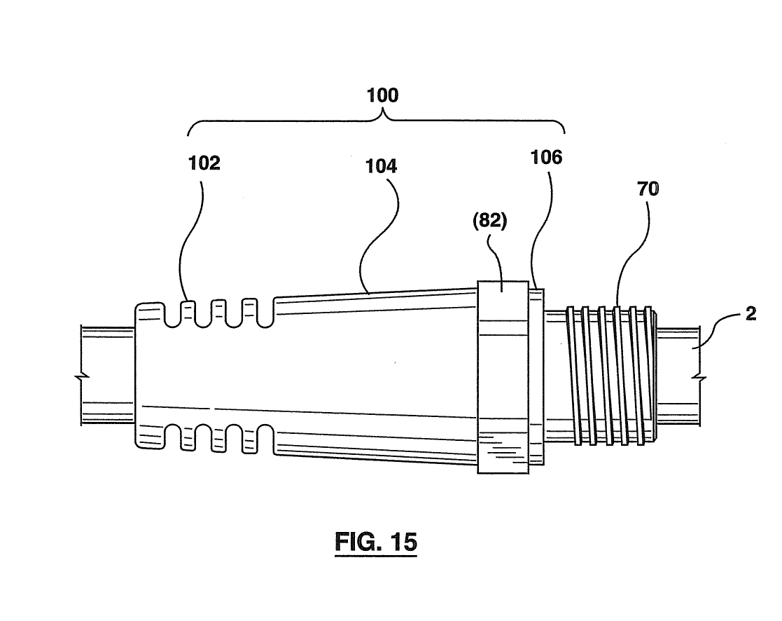

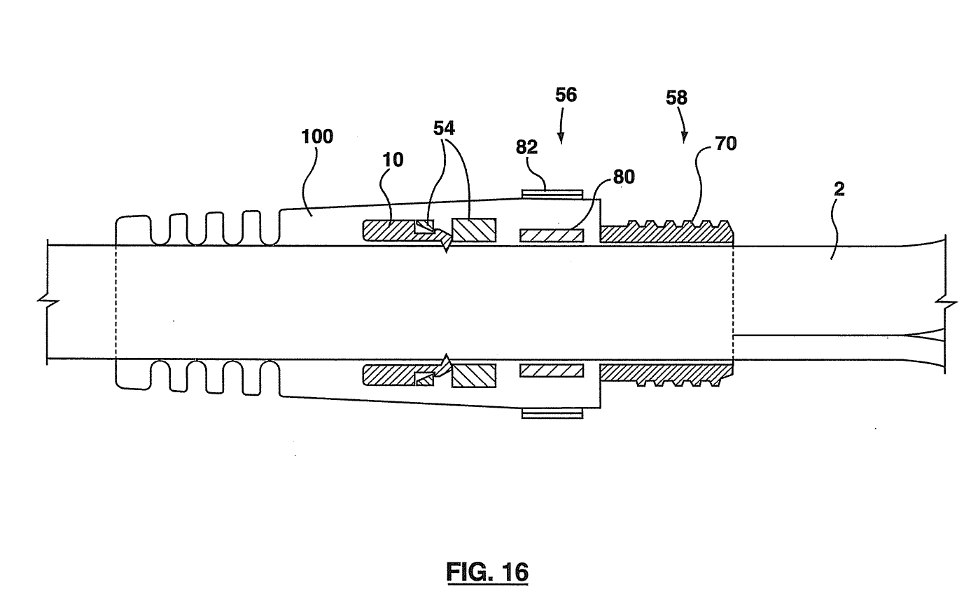

Referring to FIGS. 1-17, a clamping and sealing strain relief for a cable in accordance with an embodiment of the present invention is described. The clamping and sealing strain relief includes a barbed fingered ferrule 10, a bushing 50 and overmold 100. A cable 2 having an outer jacket is inserted into the barbed fingered ferrule 10 (e.g., FIG. 6), and then the barbed fingered ferrule 10, together with the cable 2, is snapped into the bushing 50 (e.g., FIGS. 13-14). The bushing 50, together with the ferrule 10 and the cable 2, is overmolded 100 (e.g., FIGS. 15-16). The overmold 100 seals the cable 2, the ferrule 10 and the bushing 50 from environmental, water and dust ingression and provides a positive lock of the snapped ferrule 10 and strain relief to the cable 2.

The ferrule 10, the bushing 50, and the overmold 100 have a longitudinal axis, and “X” represents the longitudinal axis of the ferrule 10, bushing 50 and overmold 100. In the description, the terms “longitudinal axis” and “longitudinal direction” may be used interchangeably. In the description, the terms “strain relief” and “strain relief assembly” may be used interchangeably.

The barbed fingered ferrule 10 includes a main body 12 for receiving the cable 2 and a plurality of clamping and locking members 20 for clamping the cable 2 and securely locking the clamped cable 2 to the bushing 50. The main body 12 may be formed from any pliable but rigid material such as plastic or metal. The clamping and locking members 20 may be formed by the same material of the main body 12. The main body 12 is generally cylindrical, and has an opening defined by its inner surface 18. The cable 2 is inserted into the opening from the first end section 14 of the main body 12 and is pushed toward the second end section 16 of the main body 12.

The clamping and locking members 20 are circumferentially arranged on the second end section 16 of the main body 12. Each clamping and locking member 20 includes a bendable finger 22. The finger 22 includes a finger body 23 extending from the second end section 16 of the main body 12 in a direction parallel to the longitudinal axis X. The inner diameter of the finger body 23 is the same as the diameter of the main body's inner surface 18. The outer diameter of the finger body 23 is smaller than that of the main body 12 to provide flexibility to the finger 22.

The finger 22 includes barbs (sloped flanges) 24a and 24b formed at the end of the finger body 23. The inner barb 24a extends inward to the longitudinal axis X. The outer barb 24b extends outward in a direction opposite to the inner barb 24a. The inner barb 24a is formed to mechanically fasten/engage the cable 2. The outer barb 24b is formed to snap and lock into the bushing 50.

The inner diameter of the finger body 23 and the inner diameter of the main body 12 are close to the outer diameter of the cable 2 so that the barb 24a can bind into the cable outer jacket of the cable 2.

The second end section 16 of the main body 12, the outer diameter of the finger body 23 and the outer barb 24b form a recess 30 which is received by the bushing 50. Cut outs 32 are formed between the fingers 22, in a direction parallel to the longitudinal axis X. Each cut out 32 extends toward the main body 12 and forms a semicircular cut out section in the second end section 16 of the main body 12. The cut out 32 enables the finger 22 to be flexible.

The clamping and locking member 20 is bendable toward the longitudinal axis X and away from the longitudinal axis X. Upon insertion of the barbed fingered ferrule 10 over the cable 2, the barbs 24a and 24b are pushed away from the cable 2 (FIG. 6). Upon insertion of the ferrule 10 into the bushing 50, the barbs 24a and 24b are pushed toward the cable 2. As described below, the bushing 50 squeezes the finger 22 of the ferrule 10 into the cable insulation outer jacket, resulting in clamping the cable 2 in place with respect to the bushing 50.

In this example, the bushing 50 includes a locking member, a threaded member and a nut flange member, as described in detail below. The overmold 100 is made by flexible material, which provides an adhesion, sealing and strain relief to the cable 2 and provides a sealing surface to the nut flange member of the bushing 50. The threaded member and the nut flange member allow the bushing 50 to be secured to an equipment bulkhead/enclosure.

The bushing 50 includes a main body 52 that is generally cylindrical and has an opening. The main body 52 has an inner diameter large enough to allow the outer diameter of the cable 2 to fit within the bushing 50. The cable outer diameter of the cable 2 may be significantly smaller than the inner diameter of the bushing 50. A space between the cable 2 and the inner surface of the bushing 50 may be overmolded 100. The main body 52 of the bushing 50 has a first end section 54 for engaging the barbed fingered ferrule 10, an intermediate section 56, and a second end section 58.

The inner surface of the first end section 54 has a plurality of circumferentially arranged locking members 60, each receiving the corresponding clamping and locking member 20 of the barbed fingered ferrule 10. The inner surface of the first end section 54 has a section formed between a pair of the locking members 60 to fit the cut out 32 of the ferrule 10.

The locking member 60 includes a sloped groove section 62 and a cut out section 66. The groove section 62 has a slop surface 64 sloping inward to the longitudinal axis X. The slop surface 64 is designed to compress the finger 22 inward upon insertion of the ferrule 10 into the groove section 62. The slop section 64 causes the inner ferrule finger barb 24a to pinch the outer jacket of the cable 2 in the ferrule 10.

The cut out section 66 receives and snap-locks the outer ferrule finger barb 24b upon further insertion of the ferrule 10. The outer ferrule finger barb 24b locks itself inside the bushing 50 inner locking cut out 66, resulting in that the cable 2 engaged with the finger 22 to be securely locked inside the bushing 50. The cut out section 66 has an opening that is open to the outer surface of the bushing 50 and is overmolded 100.

The locking force by the locking member 60 varies in dependence upon the geometry. The groove 62 and cut out 66 geometry varies in dependence upon the structure of the finger 22. The finger 22 and the locking member 60 are designed such that the finger 22 is flexible, the barb 24b does not cut through the cable 2 outer jacket or the bushing 50, and the locking member 60 securely locks the finger 22 inside the bushing 50.

For example, the locking force is stronger when the groove 66 and the barb 24b are larger. However, if the barbs 24a and 24b are too large, the flexibility of the finger 22 is compromised due to material the thickness and the arc geometry of the ferrule 10. If the finger 22 is narrower and thus the barb 24b gets sharper, the barb 24b might cut the wall of the groove 66 and/or the cable 2 outer jacket. The finger 22 is formed so that it is narrow and thin enough to bend and have strong tensile for mechanical pull and it does not cut the cable outer jacket.

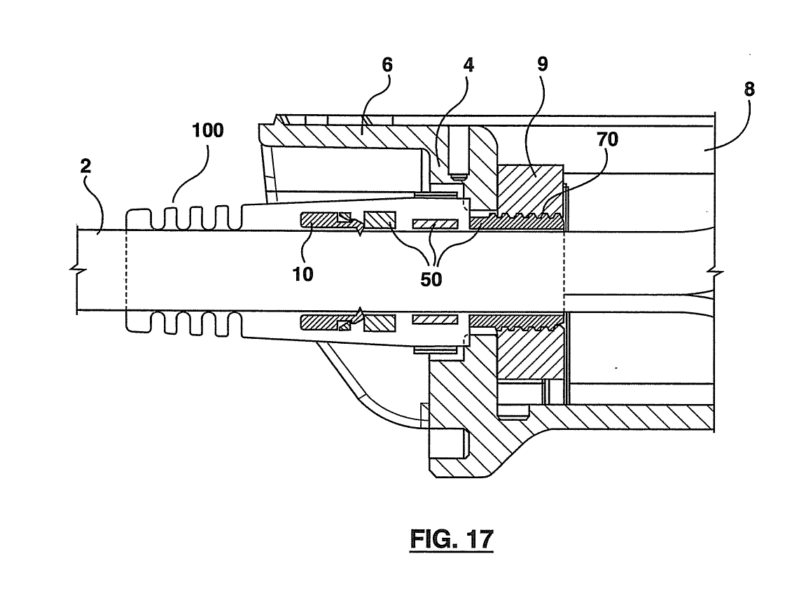

The second end section 58 of the bushing 50 may have a threaded end section 70 having threads for fastening the bushing 50 to an equipment (product) bulkhead 4 (e.g., FIG. 17). The strain relief shown in FIG. 17 is a panel mounted strain relief which is designed to fit to the panel of equipment 8. The threaded end section 70 enables the bushing intermediate section 56 (e.g., flange nut) to fit and lock into a complementary geometric feature on the equipment enclosure 6. The bushing 50 will not rotate when the nut 9 is tightened onto the bushing threaded section 58. A space (or gap) 74 between the threaded section 70 and the intermediate section 56 is overmolded 100 to provide a washer like gasket. The flange nut (section 56) side wall covered with a thin overmold which acts as a seal washer.

The intermediate section 56 of the bushing 50 includes an inner body section 80 and an outer ring section 82. The outer ring section 82 and the inner body section 80 form a space 84 that is overmolded 100. A space 86 (or gap) between the intermediate section 56 and the first end section 54 is also overmolded 100.

Any spaces (or gaps) between the cable 2 and the bushing 50/ferrule 10 are overmolded 100, including, for example, but not limited to, a space 90 between the cable 2 and the ferrule 10, a space 92 between the cable 2 and the first end section 54, a space 94 between the cable 2 and the intermediate section 56, a space 96 between the cable 2 and the second end section 58.

The overmold 100 is a thermal plastic rubber (TPR) or elastomeric (TPE) or urethane (TPU) compound that will adhere to the cable 2, the bushing 50 and the ferrule 10. Thermal plastics contract after molding process which compresses against the inward parts that are to be sealed. In one example, the bushing 50 and ferrule 10 are plastic thus the thermal plastic (TPR) (overmold 100) will bond to the plastic parts to a certain extent enhancing the sealing properties.

The overmold 100 creates two water seal features; it seals the cable 2 to the bushing 50 and the bushing 50 to the product bulkhead. The overmold 100 provides flexible material to act as a bend radius protection for the cable 2. For example, the overmold 100 has a first end section 102, an intermediate section 104 and a second end section 106. The first end section 102 acts as a bend radius control and a cable seal. The intermediate section 104 acts as a main bushing 50 seal. The second end section 106 acts as a bushing flange nut 56 seal washer.

The whole bushing 50 with the overmold 100 becomes a strain relief assembly. The strain relief here is defined as protection against strain caused by external force(s) on the cable 2, e.g., tensile, peel, torsion. The snap of the ferrule 10 into the locking member 60 of the bushing 50 provides strength into the strain relief. The external forces applied to the cable 2 will be transferred to the overmold 100 and the ferrule 10 and onto the bushing 50. Once the bushing 50 is installed on a product enclosure, these forces will be mechanically transferred to the enclosure body of the product. This provides a strong mechanical fastening of the cable 2 to the enclosure. The overmold 100 also provides additional structural strength and additional strain relief property such as controlled bend radius.

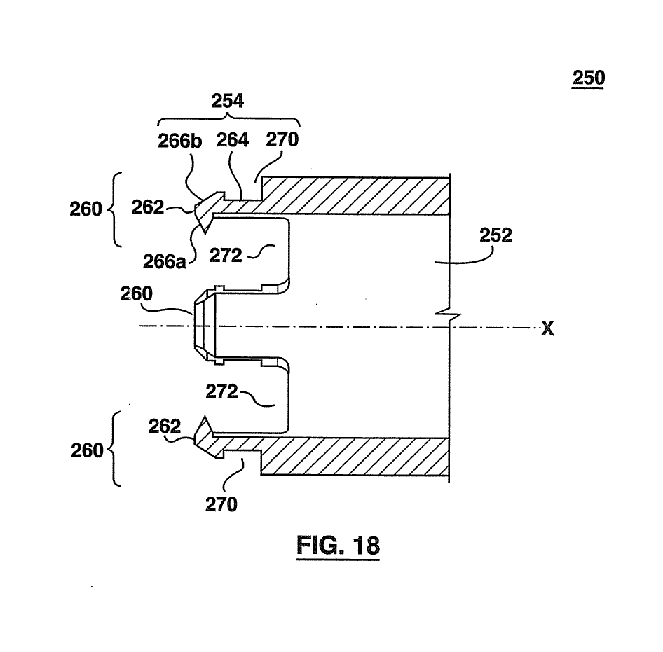

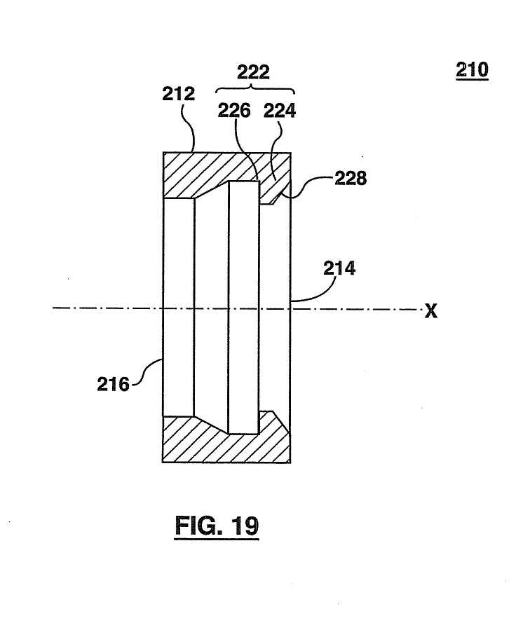

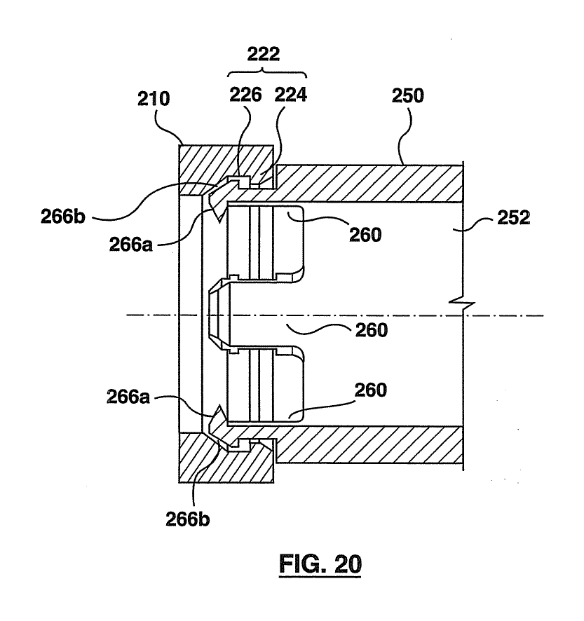

Referring to FIGS. 18-20, a clamping and sealing strain relief for a cable in accordance with another embodiment of the present invention is described. In this embodiment, the clamping and sealing strain relief includes a ferrule 210, a bushing 250 and an overmold.

The ferrule 210, the bushing 250, and the overmold have a longitudinal axis in the description, and “X” represents the longitudinal axis of the ferrule 210, the bushing 250 and the overmold.

In one example, the cable 2 having an outer jacket is inserted into the ferrule 210 and then inserted into the bushing 250. In another example, the cable 2 is inserted into the bushing 250, and then inserted into the ferrule 210. After the cable 2 is inserted into the ferrule 210 and the bushing 250, the ferrule 210 is snapped over the bushing 250 locking members (266b) forcing the bushing 250 locking members (266a) to wedge into the insulation jacket of cable 2. As a result, the cable is locked in place. The cable insertion point depends on the assembly process. For example, if the cable 2 has a finished assembled connector at one end prior to the insertion, the cable 2 will be inserted such that the connector is on the proper side of the bushing 250. The bushing 250, together with the ferrule 210 and the cable 2, is then overmolded. The overmold applied to the ferrule 210 and the bulkhead 250 may be the same or similar to the overmold 100 of FIG. 15. The side view of the overmolded cable 2, ferrule 210 and bushing 250 assembly may be the same or similar to that of FIG. 15, where the overmold seals the cable 2, the ferrule 210 and the bushing 250 from environmental, water and dust ingression and provides a positive lock of the snapped bushing 250 and strain relief to the cable 2.

The bushing 250 includes a main body 252 having an opening for receiving the cable 2. A first end section 254 extends from the main body 252 in the longitudinal axis X. The bushing 250 may include an intermediate section that is the same or similar to the intermediate section 56 of the bushing 50. The bushing 250 may include a second end section that is the same or similar to the second end section 58 of the bushing 50. The cable 2 is inserted into the bushing's main body 252 and is pushed inward into the first end section 254 of the bushing 250. The main body 252 has an inner diameter that allows the cable 2 to fit within the bushing 250.

The first end section 254 of the bushing 250 includes a plurality of clamping and locking members 260. The clamping and locking members 260 are circumferentially arranged on the end section of the main body 252. Each clamping and locking member 260 includes a bendable finger 262. The finger 262 is the same or similar to the finger 22 of the bushing 50. The finger 262 has a finger body 264 extending from the main body 252 and inner and outer barbs 266a and 266b on top of the finger body 264. The inner diameter of the finger body 264 is the same as that of the main body 252. The outer diameter of the finger body 264 and the outer barb 266b form a recess 270 that is the same or similar to the recess 30 of the ferrule 10. Cut out 272 are formed between the fingers 262, which are the same or similar to the cut out 32 of the ferrule 10.

The ferrule 210 has a main body 212, a first end section 214 and a second end section 216. The main body 212 defines an opening for receiving the clamping and locking members 260 of the bushing 250 and the cable 2. The cable 2 insertion point of the ferrule 210 is dependent on the assembly method. The cable 2 may be inserted into the ferrule 210 from the first end section 214 or the second end section 216 and pulled out from the second end section 216 or the first end section 214. If the cable 2 is inserted on the bushing 250 first, the cable 2 will be entered from the first section 214. If the ferrule 210 is inserted onto the cable 2 first, it may be done from the first end section 214 or the second end section 216, and then the bushing 250 is inserted into the ferrule 210 from the first end section 214. The cable 2 flares out the fingers 262 of the bushing 250 similar to FIG. 6. The ferrule 210 is then inserted over the finger 262 and locked on the outer barb 266b. The locked in ferrule 210 forces the inner barb 266a to wedge into the outer jacket of cable 2 similar to FIG. 10.

The ferrule 210 includes a locking member 222 having a groove geometry for receiving and snap-locking the finger 262 of the bushing 250. The locking member 222 may be the same or similar to the locking member 60 of the bushing 50. The locking member 222 includes a first groove section 224 and a second groove section 226. The first groove section 224 has a slop surface 228 sloping inward to the longitudinal axis X. The slop surface 228 is designed to compress the finger 262 inward upon insertion onto the bushing 250 into the first groove section 224. The slop surface 228 causes the outer barbs 266b to be pushed inward when the ferrule 210 is inserted, forcing the inner barb 266a to pinch the outer jacket of the cable 2.

The second groove section 226 receives and snap-locks the outer barb 266b upon further insertion of the bushing 250. The outer barb 266b locks itself inside the second groove section 226, locking the cable 2 engaged with the finger 262 to the bushing 250. The ferrule 210 may be made of metal to enhance the ferrule strength for compression.

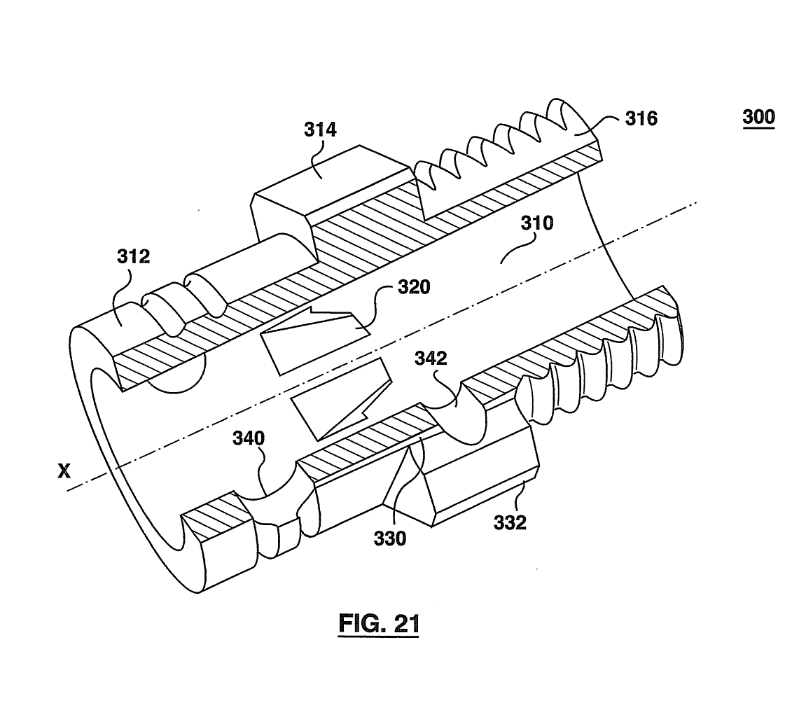

Referring to FIG. 21, a clamping and sealing strain relief for a cable in accordance with a further embodiment of the present invention is described. The bushing 300 of FIG. 21 includes a main body 310 having a first end section 312, an intermediate section 314 and a second end section 316.

The main body 310 is generally cylindrical. The cable 2 is inserted into the cylindrical opening of the main body 310 from the first end section 312 and is pushed toward the second end section 316. The main body 310 has a longitudinal axis “X”.

The inner surface of the main body 310 has a plurality of resilient locking barbs 320. The barbs 320 are bendable toward the longitudinal axis X and away from the longitudinal axis X. Upon insertion of the cable 2 into the main body 310, the barbs 320 deflect and then grab the cable outer jacket of the cable 2 since the barbs 320 push back to rest to its original position/shape. The bushing 300, together with the cable, is overmolded after insertion of the cable into the bulkhead 300. The overmold applied to the bulkhead 300 may be the same or similar to the overmold 100 of FIG. 15. The side view of the overmolded bulkhead 300 may be the same or similar to that of FIG. 15.

The first end section 312 has an opening 340 that is open to the inner space of the bushing 300 and is overmolded.

The intermediate section 314 has an inner body section 330 and an outer body section 332. The outer body section 332 and the inner body section 330 form a space that is overmolded. The intermediate section 314 has an opening 342 that is open to the inner space of the bushing 300 and is overmolded.

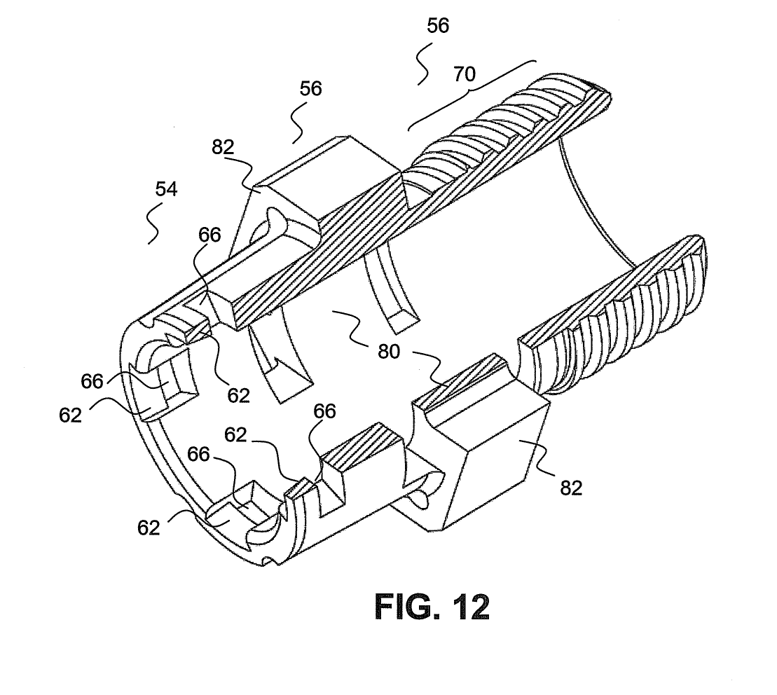

The second end section 316 includes a threaded end section that enables the bushing 300 to fit and lock into a complementary geometry feature on an equipment. The second end section 316 may the same or similar to the end section 58 of FIG. 12.

Any spaces (or gaps) between the cable 2 and the bushing 300 are overmolded.

In FIG. 21, the barbs 320 are formed close to or in the intermediate section 314; however, their positions may vary.

According to the above embodiments of the present invention, is easy to assemble strain relief (snap in ferrule) with fewer parts and without the need of tightening a compression nut.

One or more currently preferred embodiments have been described by way of example. It will be apparent to persons skilled in the art that a number of variations and modifications can be made without departing from the scope of the invention as defined in the claims.

What is claimed is:

1. A strain relief for a cable, comprising:
a first member including:
a main body having an opening for receiving a cable and a locking member, a second complementary member including:
a main body having an opening for receiving the cable; and
at least one flexible finger having a finger body extending from the main body of the second complementary member, an inner barb formed at an inner end of the finger body for engaging into the outer jacket of the cable upon insertion of the complementary second member into the main body of the first member, and an outer barb formed at an outer end of the finger body for snapping into the locking member.

2. A strain relief according to claim 1, wherein the locking member comprises:
a first groove section for compressing the outer barb inward upon the insertion of the second member into the first member such that the inner barb pinch the outer jacket of the cable; and
a second groove section for snap-locking the outer barb upon the further insertion of the second member into the first member.

3. A strain relief according to claim 1, wherein the opening of the second member comprises a diameter substantially same as an outer diameter of the cable.

4. A strain relief according to claim 1, wherein the finger is flexible such that the inner and outer barbs are pushed toward a longitudinal axis of the second member and away from the longitudinal axis of the second member.

5. A strain relief according to claim 1, wherein each of the main bodies has a substantially cylindrical shape.

6. A strain relief according to claim 1, wherein one of the first and second members is a bushing, and the other member is a ferrule.

7. A strain relief according to claim 6, wherein the bushing has a section for engaging into or, onto an equipment bulkhead/enclosure.

8. A strain relief according to claim 6, wherein the bushing comprises:
a nut flange member; and
a thread member for fitting and locking the thread flange member into or onto an equipment bulkhead/enclosure.

9. A strain relief according to claim 8, wherein the strain relief together with the cable is overmolded to provide a sealing surface to the nut flange member.

10. A strain relief according to claim 1, wherein the first member and the second member are overmolded after the inner barb engages the outer jacket of the cable and the outer barb is locked into the locking member.

11. A strain relief according to claim 10, wherein at least one of the first member and the second member comprises a threaded end section for fastening at least one of the first member and the second member to an equipment.

12. A strain relief according to claim 11, wherein the threaded end section comprises:
a first side wall enclosed by an enclosure of the equipment;
a second side wall, the second side wall being overmolded to provide a seal washer.

13. A method for a cable strain relief, the strain relief including a first member and a second member, the first member having a main body having an opening for receiving a cable and a locking member, the second member having a main body having an opening for receiving the cable and at least one flexible finger, the main body of the second member having a first end and a second end, the finger having a finger body extending from the second end of the second member and inner and outer barbs formed at the end of the finger body, the method comprising the steps of:
inserting the at least one flexible finger together with the cable into the main body of the first member, including:
compressing the finger of the second member into an outer jacket of the cable so that the inner barb of the finger pinches the outer jacket; and
snapping the outer barb of the finger into the locking member of the first member.

14. A method according to claim 13, comprising:
overmolding the first member, the second member and the cable after the step of inserting the second member.

15. A method according to claim 13, wherein at least one of the first member and the second member comprises a threaded end section for fastening the at least one member to an equipment, the method comprising:
overmolding a side wall of the thread end section to provide a seal washer.

16. A strain relief for a cable, comprising:
a main body having a substantially cylindrical inner space defined by an inner surface;
a plurality of resilient locking barbs on the inner surface of the main body, extending to the longitudinal axis of the main body, for deflecting upon insertion of a cable into the inner space and snapping an outer jacket of the cable.

17. A strain relief according to claim 16, wherein the main body comprises an outer surface and at least one opening through the outer surface and the inner surface, and wherein the main body with the cable is at least partially overmolded.

18. A strain relief according to claim 17, wherein the main body comprises an outer surface having a section for engaging an equipment.

19. A method for a cable strain relief, the strain relief including a main body having a substantially cylindrical inner space defined by an inner surface, and a plurality of resilient locking barbs on the inner surface of the main body, extending to the longitudinal axis of the main body, the method comprising the steps of:
inserting a cable into the inner space so that the barbs deflect and snap an outer jacket of the cable; and
overmolding the main body together with the cable.
